(19) United States
(12) Patent Application Publication
(10) Pub. No.: US 2007/0078835 A1
(43) Pub. Date: Apr. 5, 2007

(54) Computer system, method and software for creating and providing an individualized web-based browser interface for wrappering search results and presenting advertising to a user based upon at least one profile or user attribute

(75) Inventor: Robert M. Donnelli, Scottsdale, AZ (US)

Correspondence Address: John J G Mullins, 1618 East Gate Way #304, Pleasanton, CA, 94566, US

(73) Assignee: Boloto Group, Inc.

(21) Appl. No.: 11/540,403

(22) Filed: Sep. 28, 2006

Related U.S. Application Data
(60) Provisional application No. 60/722,489, filed on Sep. 30, 2005.

(51) Int. Cl. G06F 17/30

(52) U.S. Cl. 707/3

(57) ABSTRACT

The present invention relates generally to an individualized web-based browser interface and associated software for accessing at least one web-based search engine with the ability to wrapper and present some or all of the search results obtained from the at least one search engine in a presentation format or order that is based upon the profile of a particular end user for a computer system where the browser is installed. The invention further relates to a method for improved web-based advertising by validating advertising click-throughs of web page thumbnails or advertisements that are presented to an individual having a particular profile with respect to an advertiser's metrics in place of, or in addition to, presenting such a thumbnail from the advertiser to anyone who structures a search having certain terms or meta data criteria corresponding to a specific group of corresponding web pages.

### FIELD OF THE INVENTION

The present invention relates generally to an individualized web-based browser interface and associated software for accessing at least one web-based search engine with the ability to wrapper and present some or all of the search results obtained from the at least one search engine in a presentation format or order that is based upon the profile of a particular end user for a computer system where the browser is installed. The invention further relates to a method for improved web-based advertising by validating advertising click-throughs of web page thumbnails or advertisements that are presented to an individual having a particular profile with respect to an advertiser's metrics in place of, or in addition to, presenting such a thumbnail from the advertiser to anyone who structures a search having certain terms or meta data criteria corresponding to a specific group of corresponding web pages.

### BACKGROUND OF THE INVENTION

Of course internet search engines provide an important service to web users by locating relevant web sites for web users and providing advertising that for products and services that the web user may be interested in obtaining. Often search results that are provided by modern search engines too many sites irrelevant results to efficiently sort through and the advertiser data that is presented traditionally on the right side of search retrieval are based upon the search terms presented to the search engine and search history instead of the the prioritized advertiser data presented to the searcher often are present to persons having no interest in the particular product, service or information of the advertiser and result in false click throughs with corresponding advertiser dollars for wasted click-throughs.

False click throughs can be very annoying, distracting and unproductive for both an end user searcher and advertiser, since they are often dismissed by the searcher as being useless and avoided by paging down or back and forth through search results until hits the searcher desires are found. Narrowing down search results and removing junk hits to return better quality advertising, better quality search results and fewer sites to the searcher are challenging. This is becoming increasingly difficult as a great number of web sites continue to be added to the web daily. Search engines and browsers technologies have been implemented to provide better searching and advertising strategies, typically by better managing of the large amount of data being searched, through the use of cookies and search histories. However, much improvement is needed.

U.S. Pat. No. 6,070,159, “Method and Apparatus for Expandable Biometric Searching,” issued on May 30, 2000 to Wilson et al., which is hereby incorporated by reference, discloses a searching method that assigns data to a data group and then to a search engine. The result is a system for efficiently storing data in a large database so that it can be more easily matched using biometric data (e.g., fingerprints, facial shapes, etc.).

U.S. Pat. No. 6,185,576, “Defining a Uniform Subject Classification System Incorporating Document Management/Record Retention Functions,” issued on Feb. 6, 2001 to McIntosh, which is hereby incorporated by reference, discloses a technique for classifying documents by their subject in order to better manage the life cycle of each document.

U.S. Pat. No. 6,947,924, “Group Based Search Engine Generating Search Results Based on at Least one Nomination Previously Made by Member of the User Group Wherein Nomination is Independent of Visitation System, provides a search engine system and plug-in that allows an end user within a group to influence search results for other users classified within a group independently of the particular user's individual desires. This may provide an improved group searching experience, that may, or may not, be desired by the searcher, but it does not provide an individualized searcher interface based upon the searcher profile or attributes. The '924 patent provides only a group-based search engine for locating web pages, comprising a system for associating a user group with a web search; and a search system for generating a list of search results ordered by a ranking in response to the web search, wherein the ranking is based on at least one nomination previously made by a member of the user group. The ranking is not based upon a nomination made by the individual searcher, or that is based upon the profile of the searcher irrespective of nominations made by others.

While the above disclosures provide improved mechanisms for managing and retrieving data, and provide end users with user group data searching, none provide for a more individualized end user searching experience of parsing and presenting results and advertisements when searching web pages on the internet.

### SUMMARY OF THE INVENTION

An object of the present invention is to provide an individualized web-based browser interface and associated software for accessing at least one web-based search engine with the ability to wrapper and present some or all of the search results obtained by at least one search engine in a presentation format or order that is based upon the profile or attribute of a particular end user for a computer system where the browser is installed. In a preferred embodiment, the profile or attribute that influence at least one of the search results, the order of the search results, the advertiser data presented or the order of the advertiser data presented are a profile or attribute available to a private network system as part of a private data source in the private network to which the end user belongs and the wrapper is implemented once the end user accesses the private network.

A further object of the present invention is to provide a method for improved web-based advertising by validating advertising click-throughs of web page thumbnails or advertisements that are presented to an individual having a particular profile with respect to an advertiser's metrics in place of, or in addition to, presenting such a thumbnail from the advertiser to anyone who structures a search having certain terms or meta data criteria corresponding to a specific group of corresponding web pages.

A more particular object of the invention individualized web-based browser wrapper is a browser system and associated software designed to present traditional search results with search engine featured advertisers in at least one presentation window, frame or area, while providing in other browser areas individualized shortcut user buttons and optionally picture in search thumbnails that are tailored to the profile of the user and their individual preferences for web access. In a preferred object, the invention provides in a portion of the browser at least one individualized picture in search (or “PIS”) display area as a thumbnail of a webpage or advertiser thumbnails with a link to a webpage that would require a click through of the PIS by the searcher in order for the searcher to access its at least one corresponding web page. In a further preferred object, the PIS display areas and their order of display are based upon both the search terms and at least one end user searcher profile or attribute accessed from the private network and are independent of the advertiser order or web page hits displayed by the search engine in a separate area of the browser.

Another preferred object of the invention is to provide at least one interface and associated software for an end user of the browser to add or remove at least one denomination or attribute that would influence the content of PIS display areas presented, the order of PIS display areas, or both content and order.

In a preferred object the invention provides an individualized web-browser having buttons or shortcuts for accessing goods and services on the private network that are only available to members of the private network. In a preferred object, the private network provides an individualized identity referred to as a member card, such as the “Boloto Card”, “The Library Card”, or some other member card denomination that requires logging in to the private network in a way that positively and securely identifies the end user who is a member of the private network. In a further object, goods and services in the private network are offered to individual members of the private network as end users.

A further object of the invention is to provide PIS display areas that are presented in a hierarchy based upon user profiles or interest and may be further prioritized or rearranged according to geographic or other priority criteria. In a further preferred object, the PIS display areas are displayed according to an order based upon an advertiser exchange, or auction, for end users having a particular denomination, profile or interest.

### DISCRIPTION THE INVENTION

### Definitions and Nomenclature

“Library card” or “Boloto card” as used in the specification and the appended claims refer to a computer file or files that includes unique information and keys associated with an individual person and an individual computer system that may be used with an information decryption system to present decrypted digital information to just that particular individual on that individual computer system. For an even higher lever of security the library card can be associated with a unique device and/or unique user identifier, such as an imbedded software or hardware identifier in a device or in the case of a unique user identifier . . . a password system, a retinal scanner identifier, a unique electronic identity card, a fingerprint recognition device or the like.

The term “digital media” refers to digitized audio, video or synchronized audio and video, and even to computer software.

The term “encryption” in the context of digital media refers to the use of one or more algorithms to translate digital information into a form that is not readable without the use of a key and software routine that can convert the encrypted file back into its original form. The use of the phrase “multiply encrypted” refers to a process of subjecting encrypted data to one or more additional encryptions.

The terms “decryption” and “multiply decrypted” are the opposite (reverse) procedure as described in “encryption” and “multiply encrypted” procedures described above and use one or more keys and/or software algorithm libraries to accomplish returning encrypted information to its original un-encrypted form.

The terms “point-blank-exchange” or “Boloto exchange” refer to a computer system that allows advertisers to bid with the network manager(s)' for the right to sponsor and pay for the use by a particular end user or group of encrypted media, software, goods or services, such that the sponsor can bid for the right of to target individual or groups of end users having a digital library card and offer to pay for the library card user's access to digital media, end user software, or other sponsored events (goods or services) in exchange for targeted advertising within the private network of end users.

The term “sponsored events” may refer to use of digital media, software, communications network use and the like that requires an end user license fee or royalty or payment for use time, however, the term “events” may refer to goods and services as well that may be sponsored and involve payment by the sponsor for a particular member of the private network to use certain goods and services, such as use of commercial resources not limited to searches for financing or items, for fee data resources use, translation services, broker services, financial transactions, postage and handling, and just about any other good or service imaginable for which an end user could expect to pay to user or purchase.

The term “metadata” in an object data programming language context refers to information about the content of programming objects or data objects. One may think of it in lay terms as a description summary or index for describing present content or possible future content for an object programming language object. For example, chunks or pieces of digital data (whether encrypted or decrypted) may exist in an object or in a group of objects that are linked together in an object schema (structure or order).

Other object programming language terms and internet terms are to be given their ordinary and expected meaning within the context of this application. A meaning for such terms can be readily obtained by reviewing descriptive literature that is available from the author and provider of such object programming languages.

The term “distributed intelligent torrent exchange” or “DITX” is based upon the concept of packets of information that are embedded with metadata that causes the packets to become programming objects that are self-aware and are also aware of the group of objects to which they belong. Therefore a DITX exchange is where an end user, machine device or network requests a media file from a distributed computer system (such as the internet or another distributed network) and an intelligent torrent of packets are sent like a swarm of bees from multiple distributed locations to the requesting location. The DITX file transfer results from a DITX request initiated by an end user location that prompts the self-aware individual packets to respond by intelligently requesting their machine or network location to send a torrent of packets to the requesting location where they are unencrypted and re-assembled into the media file needed by the requester. Since the individual packets are self-aware multiple locations can send an intelligent swarm of packets to the requesting location and provide a “parallel” instead of a “serial” file transfer exchange that is much faster than obtaining packets serially from one or more locations. This maximizes the bandwidth file download time, and still provides a method for a file transfer exchange that will require decryption and reassembly of the individual packets by the end user location whereby direct or indirect payment for use of the media file can be managed and controlled by the ultimate owner of the media file without requiring a central repository of the ultimate owner of the media file and the policing of all persons to whom the file has been transferred.

A “library card DITX file” is a media file that does not exist as a single file on an end user machine, but instead exists as a scrambled collective of individual packets of information (scattered fragment encryption technique) along with an encrypted reassembly index and at least one de-encryption software module. When the de-encryption software module determines from the library card identifier that the end user has permission to the media file the software module utilizes the encrypted reassembly index to decrypt the individual packets in their proper order to provide the media file for use of the end user.

A “NAN-e” device is a device that is embedded with a unique identifier chip or software that can be associated with a unique individual to whom that the devices belongs, such as through a specific library card holder identifier system, where library card is defined as above.

An “iTEN” or “intelligent true edge network” is a network where individual locations on the network use a NAN-e identifier, a library card identifier or a combination to permit the network to conclusively identify an end user location on a network, which then allows each location on the network to truly act as a distributed network where each location is not only a user (a “client”) but also a provider (a “server”) on the network. True intelligent two-way or multi-way networking is seamlessly provided as a result of exact identification for each location on the network. Such a network provides much better security and facilitates electronic commerce in a way that was never before possible.

### DETAILS OF THE INVENTION

The present invention provides an individualized web-based browser interface and associated software for accessing at least one web-based search engine with the ability to wrapper and present some or all of the search results obtained by at least one search engine in a presentation format or order that is based upon the profile or attribute of a particular end user for a computer system where the browser is installed.

In one aspect, the invention provides a browser interface having at least three display areas, comprising:

(i) a display area for the results and advertiser displays served up by at least one accessed search engine,

(ii) individualized shortcut buttons or hot link areas for accessing private network goods and services, and

(iii) a picture in search display area where individualized search results and individualized advertiser graphic thumbnails, text thumbnails or a combination of thumbnails are presented in an order based upon at least one attribute, interest, or profile element retrieved from at least one private network data store with respect to the attribute, interest, or profile of the searcher end user.

In a preferred aspect, the profile or attribute of the present invention that influence at least one of the search results, the order of the search results, the advertiser data presented or the order of the advertiser data presented are a profile or attribute available to a private network system as part of a private data source in the private network to which the end user belongs and the wrapper is implemented only after an end user accesses the private network as a member.

In another aspect, the present invention provides a method for improved web-based advertising by validating advertising click-throughs of web page thumbnails or advertisements that are presented to an individual having a particular profile with respect to an advertiser's metrics in place of, or in addition to, presenting such a thumbnail from the advertiser to anyone who structures a search having certain terms or meta data criteria corresponding to a specific group of corresponding web pages.

The present invention provides an individualized web-based browser wrapper comprising a browser system and associated software designed to present traditional search results with search engine featured advertisers in at least one presentation window, frame or area, while providing in other browser areas individualized shortcut user buttons and optionally picture in search thumbnails that are tailored to the profile of the user and their individual preferences for web access. In a preferred aspect, the invention provides in a portion of the browser at least one individualized picture in search (or “PIS”) display area as a thumbnail of a webpage or advertiser thumbnails with a link to a webpage that would require a click through of the PIS by the searcher in order for the searcher to access its at least one corresponding web page. In a further preferred aspect, the PIS display areas and their order of display are based upon both the search terms and at least one end user searcher profile or attribute accessed from the private network and are independent of the advertiser order or web page hits displayed by the search engine in a separate area of the browser.

Another embodiment of the invention provides at least one interface and associated software for an end user of the browser to add or remove at least one denomination or attribute that would influence the content of PIS display areas presented, the order of PIS display areas, or both content and order.

A further preferred embodiment of the invention provides an individualized web-browser having buttons or shortcuts for accessing goods and services on the private network that are only available to members of the private network. In a preferred object, the private network provides an individualized identity referred to as a member card, such as the “Boloto Card”, “The Library Card”, or some other member card denomination that requires logging in to the private network in a way that positively and securely identifies the end user who is a member of the private network. In a further object, goods and services in the private network are offered to individual members of the private network as end users.

A further embodiment of the invention provides PIS display areas that are presented in a hierarchy based upon user profiles or interest and may be further prioritized or rearranged according to geographic or other priority criteria. In a further preferred embodiment, the PIS display areas of the browser are displayed according to an order based upon an advertiser exchange, or auction, for end users having a particular denomination, profile or interest and may be paged up and down or clicked through as a browser function. The PBE or Boloto exchange open to advertisers can determine the order of PIS display areas with respect to certain goods and services and certain end users of the browser interface.

The present invention is based, in part, upon the discovery of unique ways to encrypt digital information and unique ways to associate or link the real-time decryption of that information with a particular end user and a particular computer system of that end user. Such discoveries of a scattered fragment encryption technique in combination with an encrypted reassembly index and a de-encryption software or hardware module make possible the digital library card concept, the point blank exchange (or Boloto exchange) concept, and the individualized web-browser concept. The digital information is reliably encrypted and a library card with proper access permission is required to decrypt and access the digital information. In real time a library card can be granted access to the digital media regardless of how the digital media was obtained by the library card holder. Moreover, a third party can elect in advance to provide digital media at that third party's expense to a particular target audience when that audience requests it in exchange for specifically targeted advertising. Thus, the library card holder can elect to pay for the access or to allow a third party advertiser to pay for the access (when available).

Non-Limiting Description of a Digital Library Card Example

One basic premise of the Library Card (LC), or Boloto Card (BC) Member framework is to allow accelerated collaborative content (media, images, audio, etc) sharing and distribution in a way that assures the media producer receives their just remuneration for Library Card Member's access to the collaborative content. Unlike the traditional web based distributed application, a “client” in the Library Card Member is anything but a ‘thin’ client. Each “client” is both a consumer and a distributor of media in an intelligent true edge network (iTEN) where the LC technology permits DITX transmissions file swapping. A “client” will coordinate with a master content provider that tracks the wide scale distribution of content across the virtual community. (Each client will have its own unique ID and also have unique user IDs, each with their own unique user profile, such that a user may access content from any unique client.) At the master's discretion, a “client” will either consume media directly from the master or from the Library Card Members (other clients in the virtual community). Therefore, in addition to local processing of content for analysis and application specific functions, clients will respond to the master content providers requests to actively participate in media distribution at the edge of the virtual community. In one embodiment, the Versant VAR product which has event/channel/reliable guaranteed delivery across WAN capabilities will be ideal for the Peer to Peer communications at the “edge” of the virtual community so much of its functionality can be reused in the following described implementation.

Client applications (holders of a Library Card) in the virtual community will contain a local repository of content that is of particular interest to that client application's user's interests.

The digital library card may include a physical implementation that an end user can carry with them to use when they purchase goods or services, which may be merely a unique end user identification card or a financial card such as a discount card, a payment card, a cash card, a cash transfer card, and a credit card, or both an identification and financial card. One implementation may be a card that designates a group of end users, such as a “sports club member”, “a golf club member”, “band member” and the like.

Non-Limiting Illustrative Example of Client Application with Digital Media:

The population of local content will occur in one of the following events:
1. The client will request the content as a result of a search string submitted to MCP index volume or from its predefined play list. The predefined play list consists of content already stored locally.
2. The client will request recommended content from the MCP based on the user profile upon connection to the internet and arbitrarily through the course of the online connection period. The MCP will then will replicate the content to the local store so that it is in essence “pre fetching” content for the local media player making it immediately available for playback.
3. A local skin manager which is responsible for presenting advertising will also request content in the form of xml documents stored as objects. The events are also generated upon connection to the internet and arbitrarily through the course of the online connection period.

The client will ‘directly’ connect to a Master Content Provider as its source for new content requests. We call the MCP connection ‘direct’ because it is a fixed known connection for primary content acquisition.

Since the client application serves two independent functions, local application function and distribution function, the client application will need to be designed in a Multi-Thread, Multi-Session (MTMS) model. This will give the client application independence of operation so that the users local actions are unimpeded by the asynchronous requests from the MCP to distribute local content to other Library Card Members. The whole notion of edge distribution should be considered a background process that is unknown to the local investor.

In order to logically define the “edge” of the community, a client application will need to have certain identifying information. Since network identity is insufficient to characterize the “edge” of the virtual community, identity information needs to be sufficient to both identify the client's network location and also its geographical location within the virtual community. This identity information is used to register the client with the MCP process who maps the client into the virtual community. The network location identity information needs to both identify the client's basic network identity and additionally and information necessary to identify the client as a Peer in the edge of the virtual community.

At least one Primary Session in the client application will be responsible for the direct connection with the MCP. This session(s) will request content from the MCP and process local functions specific to the application. This session will use the local repository to store media of interest, local look and feel preferences, etc. This session will work with the local repository to provide application function in the form of media analysis, playback, and user defined function, etc. It is possible that request for content from the MCP will be redirected to the “edge”. A protocol must be established with the MCP such that requests for content can be identified as coming from the MCP or the “edge”. The client will then need to delegate to a Secondary session to retrieve the content on edge responses.

Now it is entirely possible that there is more than one MCP site if the lower level requirements dictate this necessity from a scalability perspective.

At least one Secondary Session in the client application will be responsible for asynchronous distribution of content on the “edge” of the virtual community. The Primary client connection will delegate MCP requests for content distribution to this session. Since only the MCP knows about the entire virtual community, these requests from the MCP will come in the form of media target identifying information and client routing information. Each client will not know about its nearest neighbors . . . only the MCP will be able to calculate that as it will be able to address the dynamics associated with new clients coming online, leaving the network, or as clients retrieve more content locally and or purge content.

If the MCP decides not to deliver the content itself, then it will calculate nearest candidates in the virtual community and send requests for them to dynamically configure a channel to the target client. Every client will have an established “incoming” channel that is known to the MCP, so it will use this information to tell the surrounding candidates in the virtual community to allocate the new channel and replicate.

The Secondary Session will use the media target information from the request for distribution to retrieve the appropriate media from the local store. The Secondary Session will use the client routing information to setup the channel for media distribution.

How is the client routing information passed to the MCP? Is this done through some sort of pre-built/generalized peer-to-peer protocols that allow any connected client w/ Versant to communicate and collaborate?

The client routing information is passed by the local content manager to the MCP The Secondary Session will dynamically allocate a new Peer-to-Peer channel based on the client routing information and form the aggregation of objects representing the media request and replicate across the channel. In may be anticipated that in order to fulfill a distribution request in a timely manner, a pool of “hollow” distribution channels will need to be created and managed. Upon request for distribution a hollow channel will be retrieved from the pool and Peer information filled in for distribution fulfillment. The channel will need to be persistent and survive long enough to validate and guarantee delivery of the MCP request to the target client at which point the channel will return to the hollow state and be reclaimed to the pool.

At least one Secondary Session in the client will be responsible for retrieving content provide by edge fulfillment responses from the MCP. This session will be responsible for tracking and receiving segments of content from edge participating clients. When all content is retrieved the session will delegate back to the Primary session for content retrieval, assembly and processing from the local store. The MCP will also be responsible for removing non ideal peers from becoming candidates in the secondary session. It will not ask peers to contribute if their bandwidth is below 100 Kb upload and it will limit the number of peers to 5 if the requesting peer is below 100 Kb in download capacity. However it will incrementally increase the number of contributing peers by 5 for every 10 peers with like content this will allow for n+1 redundancy should a connection fail. The total number of candidate peers should never exceed the number of content segments for that content id taking into account n+1.

Master Content Provider:

The master content provider (MCP) is responsible for total content storage, control and management of the virtual community and distribution.

Content storage and retrieval will need to be managed through a meta data management layer.

Meta data such as

content id,
content description
content kind
content segment lists,
content eff date
content term date
client ids (remote content owners)
user ids (remote content user kinds)
user content lists
campaign ids
campaign values
campaign eff dates
campaign term dates
impression ids
impression date time

These will be used to quickly manage the state and manipulation of content distribution and reporting. The most critical reporting from the client back to the MCP will impression reports that will include impression id, client id, user id, campaign id, impression date time. The meta data management layer can be thought of as an intelligent indexing mechanism since it will serve to separate the virtual community from the actual storage of media. The meta data layer will provide local managers (controllers) the rules behind the events and methods they generate.

The MCP will be managing many thousands of end users. Therefore, the MCP will need to use features characteristic of application server technology, namely resource and connection pooling for scalability. Functional behavior of the MCP will be defined on a public interface declared through Session Beans and exposed to the remote client applications. In order to be performance oriented, the initial implementations of the MCP will avoid the use of Entity Beans and instead use the Session Beans over a JDO like persistence layer. The JDO layer will also consist of a Multi-Session process that manages the persistent domain model classes defining the Meta data layer and other supporting transient work flow related objects.

Much of the functionality found in the content storage and retrieval of the MCP will be the same as found in the client application because fundamentally, this storage and retrieval is indistinguishable.

The Client side will generate events back to the MCP through pre defined business rules as the meta data/indexing volume will be populated with business rule values for the local/ client controllers to retrieve and report.

Application of a Digital Library Card to Advertising Methods

To fully understand how the use of a digital library improves over the use of ordinary banners, internet cookies, and website re-direction links, one needs to consider the following contrast of their elements and limitations.

(i) The Library Card Goes Beyond the Banner

In an effort to better explain assumptions about revenue, the following justification/reasoning explains why the digital library card in context of advertising does not conform to the CPM model. This is true for several reasons, since the advertising marketing associated with a digital library card goes beyond the internet banner to deliver promotions and not advertising. The current CPM model is different the CPE for the library card and does not have the same fundamental traditional costs associated with impression and conversion associated with existing forms of advertising.

(ii) Beyond the Banner:

In addition to banner ads, there are other ways to use the Internet to communicate a marketing message. Traditionally, a banner is an advertisement in the form of a graphic image that typically runs across a Web page or is positioned in a margin or other space reserved for ads. Banner ads are usually Graphics Interchange Format (GIF) images. In addition to adhering to size, many Web sites limit the size of the file to a certain number of bytes so that the file will display quickly. Most ads are animated GIFs since animation has been shown to attract a larger percentage of user clicks. The most common larger banner ad is 468 pixels wide by 60 pixels high. Smaller sizes include 125 by 125 and 120 by 90 pixels. These and other banner sizes have been established as standard sizes by the Internet Advertising Bureau.

Beyond the banner concepts include sponsoring a Web site or a particular feature on it; advertising in e-mail newsletters; co-branding with another company and its Web site; contest promotion; and, in general, finding new ways to engage and interact with the desired audience. “Beyond the banner” approaches can also include the interstitial and streaming video infomercial. The banner itself can be transformed into a small rich media event. In the case of a digital library card, the business method can provide a hybrid of all the current web advertising methods with an interesting difference, the library card user is choosing the time and content to opt in for an impression.

(iii) Promotions not Advertising:

As mentioned above, in Web advertising an ad is almost always a banner, a graphic image or set of animated images (in a file called an animated GIF) of a designated pixel size and byte size limit. An ad or set of ads for a campaign is often referred to as “the creative.” Banners and other special advertising that include an interactive or visual element beyond the usual are known as rich media. In an effort to improve the advertisement/impression some additional techniques have been implemented”
a. Ad rotation: Ads are often rotated into ad spaces from a list. This is usually done automatically by software on the Web site or at a central site administered by an ad broker or server facility for a network of Web sites.
b. Dynamic Ad space: An ad space is a space on a Web page that is reserved for ads. A dynamic ad space group is a predefined group of spaces within a Web site that share the same characteristics so that an ad purchase can be made for the group of spaces.

More and more, advertising agencies struggle with improving there current method of operation with respect to advertising. Some current experts have suggested that interstitials promise to salvage an industry built on hype and relatively innovation less technology. However, there are signs of those who understand the value that cognitive scientists and instructional design experts have known for years and that is the ability for viewers to interact with the advertisement. Banner Ads having you pitch a baseball, chase a ghost using the “PACMAN” style are gaining increased popularity. While these ads provide some level of entertainment and short term retention, in cognitive terms; they fail to demonstrably increase recall, application and transfer. Essentially such advertisements are yet another ad view, synonymous with ad impression, measured only by limited effectiveness.

Affiliate marketing: Affiliate marketing is the use by a Web site that sells products of other Web sites, called affiliates, to help market the products. Amazon.com, the book seller, created the first large-scale affiliate program and hundreds of other companies have followed since. Such providers use links to the websites of others and the links take users to websites offering the product they are seeking.

(iv) Why CPM Does Not Apply to the Digital Library Card.

In the traditional non-accountable marketing departments, quantifying the buzz of reach, cost per impression and cost per impression; are for all intensive purposes an after the fact estimation process. From a proactive sense, this traditional “science” doesn't work really well and results in frustration of company management with projecting costs and impacts for advertising campaigns and accurately identifying which advertising has been effective.

CPM may be currently defined as “cost per thousand” ad impressions, an industry standard measure for selling ads on Web sites. This measure is taken from print advertising. The “M” has nothing to do with “mega” or million. It's taken from the Roman numeral for “thousand.” More recently the acronym CPTM, or “cost per thousand targeted” ad impressions, is a term implying that the audience you're selling is targeted to particular demographics.

A digital library card can be associated with user demographics and marketing factor information that can be directly targeted by advertisers. This is well beyond CPTM because an educated end user will recognize that the value they associate with the content they personally choose is worth giving up some degree of information that can be utilized by marketers.

In one embodiment and system for obtaining demographic and marketing targeting information an amnesty library card registration is used. In essence the digital library concept in association with advertising and marketing goes beyond an “opt-in” surrendering of personal information to a value exchange. In affiliation with media providers, amnesty can be provided to registering library card holders for past possible illegal use of digital media (non-payment) if they answer certain identifying questions and agree to become a digital library card holder. In exchange for the pre-existing content of their choosing a network citizen becomes a library card user because they now have the ability to transform their existing content into a vehicle for amnesty, engage in supporting their artists they enjoy and more importantly gain a freedom in choice they only could have if they engaged in illegally or at best immorally. This virtual act of reconciliation allows the past concepts of advertising to be completely rewritten as the industry vernacular associated with ads, booked space, cost per click etc are redefined.

If a digital library card system of advertising becomes widely accepted, internet citizens will no longer be ambushed by undesired pop ups and banners on a website they chose to go to or through the use of a non specific search engine. Instead, they are presented with opportunity that is targeted to them and only them. They will agree to allow this targeting in the ultimate of cognitive environments and with a level of affiliation advertisers in the past could only dream of. When Car commercials insert the Rolling Stones or Madonna into an advertisement they are limited to the acceptance the audience has of Madonna and or the Rolling Stones. If the targeted audience finds the inserted music offensive they will not make a good impression. The known tastes of the digital library card user will allow the advertiser to choose a song that is acceptable to the end user. In this way, positive emotion is conveyed and affiliated with the content and the brand.

Below is one assessment of the digital library card advertising method's potential changes/impact on existing terminology

| Term | Definition | Library Card Impact |
|---|---|---|
| Booked space | is the number of ad views for an ad | Never a sold out space with |
| | space that are currently sold out | the exchange value is |
| | | determined by good old |
| | | fashioned supply and |
| | | demand. Booked Space is |
| | | only if you can't afford it or |
| | | are unwilling to relax your |
| | | specificity |
| Brand, brand | A brand is a product, service, or | The library card user |
| name, and | concept that is publicly distinguished | strengthens the brand |
| branding | from other products, services, or | because their decision about |
| | concepts so that it can be easily | the content has value and |
| | communicated and usually marketed. | emotion associated with it. |
| | A brand name is the name of the | Thereby providing the |
| | distinctive product, service, or | opportunity to transfer that |
| | concept. Branding is the process of | emotion to the brand. While |
| | creating and disseminating the brand | there are some negative |
| | name. Branding can be applied to the | connotations associated |
| | entire corporate identity as well as to | with this, the ability to |
| | individual product and service names. | affiliate brands together |
| | In Web and other media advertising, | through content choice |
| | it is recognized that there is usually | outweighs them. (ex. |
| | some kind of branding value whether | Doritos and Coca Cola |
| | or not an immediate, direct response | Impressions following each |
| | can be measured from an ad or | other, Outback steakhouse |
| | campaign. Companies like Proctor | and Foster's Beer etc. |
| | and Gamble have made a science out | |
| | of creating and evaluating the success | |
| | of their brand name products | |
| Caching: | In Internet advertising, the caching of | With the digital library card |
| | pages in a cache server or the user's | advertising method caching |
| | computer means that some ad views | provides the opportunity to |
| | won't be known by the ad counting | track off line transactions. |
| | programs and is a source of concern. | Caching is not an issue |
| | There are several techniques for | anymore. |
| | telling the browser not to cache | |
| | particular pages. On the other hand, | |
| | specifying no caching for all pages | |
| | may mean that users will find your | |
| | site to be slower than you would like. | |
| Click | According to ad industry | The digital library card user |
| | recommended guidelines from FAST, | clicks the ad to get a real |
| | a click is “when a visitor interacts | desired result, a change of |
| | with an advertisement.” This does not | content, looking up new |
| | apparently mean simply interacting | content. Not sent to another |
| | with a rich media ad, but actually | ad |
| | clicking on it so that the visitor is | |
| | headed toward the advertiser's | |
| | destination. (It also does not mean | |
| | that the visitor actually waits to fully | |
| | arrive at the destination, but just that | |
| | the visitor started going there.) | |
| Click stream: | A click stream is a recorded path of | The digital library card |
| | the pages a user requested in going | experience is recorded |
| | through one or more Web sites. Click | every time they interact, |
| | stream information can help Web site | period recording |
| | owners understand how visitors are | everything. Analysis |
| | using their site and which pages are | becomes a by product |
| | getting the most use. It can help | |
| | advertisers understand how users get | |
| | to the client's pages, what pages they | |
| | look at, and how they go about | |
| | ordering a product. | |
| Clickthrough: | A clickthrough is what is counted by | With the digital library card |
| | the sponsoring site as a result of an ad | the click through doesn't |
| | click. In practice, click and | happen unless they interact |
| | clickthrough tend to be used | with the player, thereby the |
| | interchangeably. A clickthrough, | mere selection of content |
| | however, seems to imply that the user | promotes click through |
| | actually received the page. A few | |
| | advertisers are willing to pay only for | |
| | clickthroughs rather than for ad | |
| | impressions. | |
| Click rate: | The click rate is the percentage of ad | Every impression is click |
| | views that resulted in clickthroughs. | rate, no longer measured by |
| | Although there is visibility and | percentage. You know your |
| | branding value in ad views that | message is given exactly to |
| | doesn't result in a clickthrough, this | the person you are looking |
| | value is difficult to measure. A | for. Clickthroughs only |
| | clickthrough has several values: it's | provide a % of target you |
| | an indication of the ad's effectiveness | never know if you reached |
| | and it results in the viewer getting to | |
| | the advertiser's Web site where other | |
| | messages can be provided. A new | |
| | approach is for a click to result not in | |
| | a link to another site but to an | |
| | immediate product order window. | |
| | What a successful click rate is | |
| | depends on a number of factors, such | |
| | as: the campaign objectives, how | |
| | enticing the banner message is, how | |
| | explicit the message is (a message | |
| | that is complete within the banner | |
| | may be less apt to be clicked), | |
| | audience/message matching, how new | |
| | the banner is, how often it is | |
| | displayed to the same user, and so | |
| | forth. In general, click rates for high- | |
| | repeat, branding banners vary from | |
| | 0.15 to 1%. Ads with provocative, | |
| | mysterious, or other compelling | |
| | content can induce click rates ranging | |
| | from 1 to 5% and sometimes higher. | |
| | The click rate for a given ad tends to | |
| | diminish with repeated exposure. | |
| Co-branding | Co-branding on the Web often means | Co Branded doesn't require |
| | two Web sites or Web site sections or | our users to go anywhere, |
| | features displaying their logos (and | Pepsi and Taco Bell can be |
| | thus their brands) together so that the | the same player or be one |
| | viewer considers the site or feature to | after the next. This |
| | be a joint enterprise. (Co-branding is | redefines co branding and |
| | often associated with cross-linking | the concept of affiliate |
| | between the sites, although it isn't | marketing |
| | necessary.) | |
| Cookie: | A cookie is a file on a Web user's | Bye Bye. No unpopular |
| | hard drive (it's kept in one of the | internet cookies |
| | subdirectories under the browser file | |
| | directory) that is used by Web sites to | |
| | record data about the user. Some ad | |
| | rotation software uses cookies to see | |
| | which ad the user has just seen so that | |
| | a different ad will be rotated into the | |
| | next page view. | |
| CPA Cost-per- | Cost-per-action is what an advertiser | The content by its very |
| action: | pays for each visitor that takes some | selection provides a cost per |
| | specifically defined action in response | action. If someone chooses |
| | to an ad beyond simply clicking on it. | to learn more about the |
| | For example, a visitor might visit an | promotion being presented |
| | advertiser's site and request to be | it is a qualified lead. Not a |
| | subscribed to their newsletter. | potential one. |
| Cost-per-lead | This is a more specific form of cost- | Same as above |
| | per-action in which a visitor provides | |
| | enough information at the advertiser's | |
| | site (or in interaction with a rich | |
| | media ad) to be used as a sales lead. | |
| | Note that you can estimate cost-per- | |
| | lead regardless of how you pay for | |
| | the ad (in other words, buying on a | |
| | pay-per-lead basis is not required to | |
| | calculate the cost-per-lead). | |
| Cost-per-sale: | Sites that sell products directly from | Same as above |
| | their Web site or can otherwise | |
| | determine sales generated as the | |
| | result of an advertising sales lead can | |
| | calculate the cost-per-sale of Web | |
| | advertising | |
| Creative | Ad agencies and buyers often refer to | The creative part starts at |
| | ad banners and other forms of created | the beginning of an |
| | advertising as ““the creative.” Since | advertiser's campaign |
| | the creative requires creative | bidding process at the Point |
| | inspiration and skill that may come | Blank Exchange. It |
| | from a third party, it often doesn't | becomes the very essence of |
| | arrive until late in the preparation for | the campaign launch. |
| | a new campaign launch. | |
| Demographics | Demographics are data about the size | Ours is verified at the time |
| | and characteristics of a population or | of Library Card Download. |
| | audience (for example, gender, age | No costly verification |
| | group, income group, purchasing | process required. |
| | history, personal preferences, and so | |
| | forth). | |
| Filtering | Filtering is the immediate analysis by | The digital library card |
| | a program of a user Web page request | user's filter themselves by |
| | in order to determine which ad or ads | content selection and |
| | to return in the requested page. A | merely by joining the digital |
| | Web page request can tell a Web site | library card organization. |
| | or its ad server whether it fits a | The Point Blank Exchange |
| | certain characteristic such as coming | presents these |
| | from a particular company's address | demographics to the |
| | or that the user is using a particular | sponsor, advertiser or |
| | level of browser. The Web ad server | marketer. |
| | can respond accordingly. | |
| Fold | “Above the fold,” a term borrowed | The library card media |
| | from print media, refers to an ad that | experiences can be designed |
| | is viewable as soon as the Web page | for an 800 × 600 event; no |
| | arrives. You don't have to scroll down | scrolling ever. Even when |
| | (or sideways) to see it. Since screen | the user minimizes the |
| | resolution can affect what is | window . . . the branding still |
| | immediately viewable, it's good to | occurs! |
| | know whether the Web site's audience | |
| | tends to set their resolution at 640 by | |
| | 480 pixels or at 800 by 600 (or | |
| | higher). | |
| Hit | A hit is the sending of a single file | The advertiser does not |
| | whether an HTML file, an image, an | need to track hits anymore. |
| | audio file, or other file type. Since a | The more effective data to |
| | single Web page request can bring | track its experiences. |
| | with it a number of individual files, | |
| | the number of hits from a site is a not | |
| | a good indication of its actual use | |
| | (number of visitors). It does have | |
| | meaning for the Web site space | |
| | provider, however, as an indicator of | |
| | traffic flow. | |
| Impression | According to the “Basic Advertising | Impression = Experience. |
| | Measures,” from FAST, an ad | No CPM |
| | industry group, an impression is “The | |
| | count of a delivered basic advertising | |
| | unit from an ad distribution point.” | |
| | Impressions are how most Web | |
| | advertising is sold and the cost is | |
| | quoted in terms of the cost per | |
| | thousand impressions (CPM). | |
| Insertion order: | An insertion order is a formal, printed | Sponsors do not pay unless |
| | order to run an ad campaign. | the experience occurs |
| | Typically, the insertion order | |
| | identifies the campaign name, the | |
| | Web site receiving the order and the | |
| | planner or buyer giving the order, the | |
| | individual ads to be run (or who will | |
| | provide them), the ad sizes, the | |
| | campaign beginning and end dates, | |
| | the CPM, the total cost, discounts to | |
| | be applied, and reporting | |
| | requirements and possible penalties or | |
| | stipulations relative to the failure to | |
| | deliver the impressions. | |
| Inventory: | Inventory is the total number of ad | The inventory is the |
| | views or impressions that a Web site | membership base of the |
| | has to sell over a given period of time | library card organization |
| | (usually, inventory is figured by the | |
| | month). | |
| Media broker | Since it's often not efficient for an | The Point Blank Exchange |
| | advertiser to select every Web site it | (“PBE”) is the ultimate |
| | wants to put ads on, media brokers' | Media Broker |
| | aggregate sites for advertisers and | |
| | their media planners and buyers, | |
| | based on demographics and other | |
| | factors. | |
| Media buyer | A media buyer, usually at an | At the PBE anyone is a |
| | advertising agency, works with a | Media Buyer |
| | media planner to allocate the money | |
| | provided for an advertising campaign | |
| | among specific print or online media | |
| | (magazines, TV, Web sites, and so | |
| | forth), and then calls and places the | |
| | advertising orders. On the Web, | |
| | placing the order often includes | |
| | requesting proposals and negotiating | |
| | the final cost. | |
| Opt-in e-mail | Opt-in e-mail is e-mail containing | Spam can be a thing of the |
| | information or advertising that users | past for advertisers. |
| | explicitly request (opt) to receive. | |
| | Typically, a Web site invites its | |
| | visitors to fill out forms identifying | |
| | subject or product categories that | |
| | interest them and about which they | |
| | are willing to receive e-mail from | |
| | anyone who might send it. The Web | |
| | site sells the names (with explicit or | |
| | implicit permission from their | |
| | visitors) to a company that specializes | |
| | in collecting mailing lists that | |
| | represent different interests. | |
| | Whenever the mailing list company | |
| | sells its lists to advertisers, the Web | |
| | site is paid a small amount for each | |
| | name that it generated for the list. | |
| | You can sometimes identify opt-in e- | |
| | mail because it starts with a statement | |
| | that tells you that you have previously | |
| | agreed to receive such messages. | |
| Pay-per-click | In pay-per-click advertising, the | An advertiser can bid for |
| | advertiser pays a certain amount for | their CPE based on their |
| | each clickthrough to the advertiser's | desired level of specificity. |
| | Web site. The amount paid per | |
| | clickthrough is arranged at the time of | |
| | the insertion order and varies | |
| | considerably. Higher pay-per-click | |
| | rates recognize that there may be | |
| | some “no-click” branding value as | |
| | well as clickthrough value provided. | |
| Pay-per-lead | In pay-per-lead advertising, the | Any leads generated are |
| | advertiser pays for each sales lead | paid in one fee at the Bid |
| | generated. For example, an advertiser | price |
| | might pay for every visitor that | |
| | clicked on a site and then filled out a | |
| | form. | |
| Pay-per-sale | Pay-per-sale is not customarily used | The populators of the PBE |
| | for ad buys. It is, however, the | can enjoy payment for CPE |
| | customary way to pay Web sites that | |
| | participate in affiliate programs, such | |
| | as those of Amazon.com and | |
| | Beyond.com. | |
| Pay-per-view | Since this is the prevalent type of ad | See above |
| | buying arrangement at larger Web | |
| | sites, this term tends to be used only | |
| | when comparing this most prevalent | |
| | method with pay-per-click and other | |
| | methods. | |
| Proof of | Some advertisers may want proof that | Real time reports at the |
| performance | the ads they've bought have actually | PBE |
| | run and that clickthrough figures are | |
| | accurate. In print media, tear sheets | |
| | taken from a publication prove that an | |
| | ad was run. On the Web, there is no | |
| | industry-wide practice for proof of | |
| | performance. Some buyers rely on the | |
| | integrity of the media broker and the | |
| | Web site. The ad buyer usually | |
| | checks the Web site to determine the | |
| | ads are actually running. Most buyers | |
| | require weekly figures during a | |
| | campaign. A few want to look | |
| | directly at the figures, viewing the ad | |
| | server or Web site reporting tool. | |
| Psychographic | This is a term for personal interest | The data collect for digital |
| characteristics | information that is gathered by Web | library card registration is |
| | sites by requesting it from users. For | associated w/ content types |
| | example, a Web site could ask users | |
| | to list the Web sites that they visit | |
| | most often. Advertisers could use this | |
| | data to help create a demographic | |
| | profile for that site. | |
| Reporting | Although the media have to report | The one embodiment the |
| template | data to ad agencies and media | data uses eBXML for |
| | planners and buyers during and at the | precisely that reason. |
| | end of each campaign, no standard | |
| | report is yet available. FAST, the ad | |
| | industry coalition, is working on a | |
| | proposed standard reporting template | |
| | that would enable reporting to be | |
| | consistent | |
| rich media | Rich media is advertising that | No explanation required. |
| | contains perceptual or interactive | The media for PBE is rich |
| | elements more elaborate than the | media |
| | usual banner ad. Today, the term is | |
| | often used for banner ads with popup | |
| | menus that let the visitor select a | |
| | particular page to link to on the | |
| | advertiser's site. Rich media ads are | |
| | generally more challenging to create | |
| | and to serve. Some early studies have | |
| | shown that rich media ads tend to be | |
| | more effective than ordinary animated | |
| | banner ads. | |
| ROI | ROI (return on investment) is “the | Each product manager will |
| | bottom line” on how successful an ad | be able to correlate their |
| | or campaign was in terms of what the | sales directly to their |
| | returns (generally sales revenue) were | campaigns |
| | for the money expended (invested). | |
| Run-of-network | A run-of-network ad is one that is | We are the network |
| | placed to run on all sites within a | |
| | given network of sites. Ad sales firms | |
| | handle run-of-network insertion | |
| | orders in such a way as to optimize | |
| | results for the buyer consistent with | |
| | higher priority ad commitments. | |
| Run-of-site | A run-of-site ad is one that is placed | No sites required. Every |
| | to rotate on all non-featured ad spaces | promotion is specially |
| | on a site. CPM rates for run-of-site | placed |
| | ads are usually less than for rates for | |
| | specially-placed ads or sponsorships. | |
| Splash page | A splash page (also known as an | The library card media |
| | interstitial) is a preliminary page that | player is capable of splash |
| | precedes the regular home page of a | and immersion, combining |
| | Web site and usually promotes a | virtual reality and flash |
| | particular site feature or provides | technologies on the library |
| | advertising. A splash page is timed to | card users desktop |
| | move on to the home page after a | |
| | short period of time. | |
| Sponsor | Depending on the context, a sponsor | Same, no website required |
| | simply means an advertiser who has | |
| | sponsored an ad and, by doing so, has | |
| | also helped sponsor or sustain the | |
| | Web site itself. It can also mean an | |
| | advertiser that has a special | |
| | relationship with the Web site and | |
| | supports a special feature of a Web | |
| | site, such as a writer's column, a | |
| | Flower-of-the-Day, or a collection of | |
| | articles on a particular subject | |
| Sponsorship | Sponsorship is an association with a | See above |
| | Web site in some way that gives an | |
| | advertiser some particular visibility | |
| | and advantage above that of run-of- | |
| | site advertising. When associated | |
| | with specific content, sponsorship can | |
| | provide a more targeted audience than | |
| | run-of-site ad buys. Sponsorship also | |
| | implies a “synergy and resonance” | |
| | between the Web site and the | |
| | advertiser. Some sponsorships are | |
| | available as value-added | |
| | opportunities for advertisers who buy | |
| | a certain minimum amount of | |
| | advertising. | |
| Targeting | Targeting is purchasing ad space on | Targeting is achieved upon |
| | Web sites that match audience and | new user signup and |
| | campaign objective requirements. | facilitated through the point |
| | Techtarget.com, with over 20 Web | blank exchange |
| | sites targeted to special information | |
| | technology audiences, is an example | |
| | of an online publishing business built | |
| | to enable advertising targeting | |
| Unique visitor | A unique visitor is someone with a | The unique user is a unique |
| | unique address who is entering a Web | experience as well every |
| | site for the first time that day (or | piece of content is unique to |
| | some other specified period). Thus, a | the user as the promotion is |
| | visitor that returns within the same | unique to the user. |
| | day is not counted twice. A unique | |
| | visitors count tells you how many | |
| | different people there are in your | |
| | audience during the time period, but | |
| | not how much they used the site | |
| | during the period. | |
| User session | A user session is someone with a | The length of the content is |
| | unique address that enters or reenters | unique |
| | a Web site each day (or some other | |
| | specified period). A user session is | |
| | sometimes determined by counting | |
| | only those users that haven't reentered | |
| | the site within the past 20 minutes or | |
| | a similar period. User session figures | |
| | are sometimes used, somewhat | |
| | incorrectly, to indicate “visits” or | |
| | “visitors” per day. User sessions are a | |
| | better indicator of total site activity | |
| | than “unique visitors” since they | |
| | indicate frequency of use. | |
| View: | A view is, depending on what's | No pages or browser |
| | meant, either an ad view or a page | required |
| | view. Usually an ad view is what's | |
| | meant. There can be multiple ad | |
| | views per page views. View counting | |
| | should consider that a small | |
| | percentage of users choose to turn the | |
| | graphics off (not display the images) | |
| | in their browser. | |
| Visit | A visit is a Web user with a unique | N/A |
| | address entering a Web site at some | |
| | page for the first time that day (or for | |
| | the first time in a lesser time period). | |
| | The number of visits is roughly | |
| | equivalent to the number of different | |
| | people that visit a site. This term is | |
| | ambiguous unless the user defines it, | |
| | since it could mean a user session or | |
| | it could mean a unique visitor that | |
| | day | |

As exemplified above, the use of a digital library card in the context of advertisers or sponsors targeting consumers will redefine the very definitions of an industry that was reborn when the dot corn boom expanded it. The digital library card and point blank exchange will provide accountability to that very same industry, and delight media buyers around the globe.

The PIS display area of the individualized browser allows for the above advertiser bidding for at least one denomination, user profile element, or interest to prioritize the advertiser area for an individualized search experience of the end user and avoid excessive “junk” click-throughs. Only end users having a high interest in the advertiser's goods or services, or a high interest in the advertiser for the attention of that end user will be presented with an advertisement. This will streamline the searching and advertising experience of the end user searcher on the private network.

Without further description, it is believed that one of ordinary skill in the art can, using the preceding description, make and utilize the business method and associated computer systems of the present invention and practice the claimed methods. The examples of individualized web-browser implementations, including encryption and decryption and the point blank exchange, specifically point out preferred embodiments of the present invention, and are not to be construed as limiting in any way the remainder of the disclosure. Such examples are non-limiting in that one of ordinary skill (in view of the above) will readily envision other permutations and variations on the invention without departing from the principal concepts. Such permutations and variations are also within the scope of the present invention.

I claim:

1. A software implemented method providing the computer system of an end user computer with an individualized web-based browser interface and associated software for accessing at least one web-based search engine with the ability to wrapper and present some or all of the search results obtained by at least one search engine in a presentation format or order that is based upon the profile or attribute of a particular end user for a computer system wherein the browser is installed.

2. A software implemented method according to claim 1, wherein the profile or attribute that influence at least one of the search results, the order of the search results, the advertiser data presented or the order of the advertiser data presented are a profile or attribute available to a private network system as part of a private data source in the private network to which the end user belongs and the wrapper is implemented once the end user accesses the private network utilizing their computer system.

3. A software implemented method according to claim 2, further providing improved web-based advertising by validating advertising click-throughs of web page thumbnails or advertisements that are presented to an individual having a particular profile with respect to an advertiser's metrics in place of, or in addition to, presenting such a thumbnail from the advertiser to anyone who structures a search having certain terms or meta data criteria corresponding to a specific group of corresponding web pages.

4. A software implemented method providing the computer system according to claim 1, wherein the system provides the end user with an individualized web-based browser wrapper intranet or internet browser system and associated software including computer implemented methods designed to present traditional search results with search engine featured advertisers in at least one presentation window, frame or area, while simultaneously providing in other browser areas of the end user browser view one or more individualized shortcut user buttons that optionally provide a picture as search thumbnails that are tailored to the attributes profile of the user and to their individual preferences for web access.

5. A software implemented method providing the computer system according to claim 4, wherein the system provides the end user with an individualized web-based browser wrapper intranet or internet browser system and associated software including computer implemented methods designed to present traditional search results with search engine featured advertisers in at least one presentation window, frame or area, while simultaneously providing in other browser areas of the end user browser view one or more individualized shortcut user buttons as an individualized picture in search (or “PIS”) display area having a thumbnail of a webpage or an advertiser thumbnails such that the PIS contains a link to a webpage that would require a click through of the PIS by the searcher in order for the searcher to access its at least one corresponding web page.

6. A software implemented method according to claim 5, wherein the one or more PIS display areas and their order of display are based upon both the search terms and at least one end user searcher profile or attribute accessed from communication with one or more user attribute profile listing located on the private network and are independent of the advertiser order or the web page hits that are displayed by communication with the one or more traditional search engines, which results are located in a separate area of the browser view.

7. A software implemented method according to claim 5, wherein the software implemented methods and software provide at least one interface and associated software for an end user who is viewing search results with the browser in order to add or remove at least one denomination or attribute that would influence the content of PIS display areas presented, the order of PIS display areas, or both content and order.

8. A software implemented method according to claim 1, wherein the software implemented methods and software provide at least one interface and associated software for an end user provides a browser view as an individualized web-browser having buttons or shortcuts for accessing goods and services on the private network that are only available to members of the private network associated with that end user.

9. A software implemented method according to claim 1, wherein the software implemented methods and software provide at least one interface and associated software for an end user provides a browser view as an individualized web-browser having buttons or shortcuts for accessing goods and services on the private network that are only available to members of the private network associated with that end user and the private network provides an individualized identity referred to as a member card, such as the “Boloto Card”, “The Library Card”, or some other member card denomination that requires logging into the private network in a way that positively and securely identifies the end user who is a member of the private network and activates the special view characteristics of the individualized browser view system.

10. A software implemented method according to claim 5, wherein the browser view is provided with PIS display areas that are presented in a hierarchy based upon user profiles or interest and may be further prioritized or rearranged according to geographic or other priority criteria of the private network, end user or both.

11. A software implemented method according to claim 10, wherein the PIS display areas of the browser view are displayed to an individual end user or group of end users according to an order that is based in part upon an advertiser exchange, or auction, for end users having a particular denomination, profile or interest for one or more advertisers.
